(19) United States
(12) Patent Application Publication
(10) Pub. No.: US 2004/0066283 A1
(43) Pub. Date: Apr. 8, 2004

(54) Power line communications system combining high bitrate and low bitrate transmissions

(76) Inventors: Constantine N. Manis, Monmouth Junction, NJ (US); Oleg Logvinov, East Brunswick, NJ (US); Lawrence Durfee, Washington, NJ (US)

Correspondence Address: Lorimer P. Brooks, Esq., Norris, McLaughlin & Marcus, P.O. Box 1018, Somerville, NJ, 08876-1018, US

(21) Appl. No.: 10/338,615

(22) Filed: Jan. 8, 2003

Related U.S. Application Data
(60) Provisional application No. 60/345,824, filed on Jan. 8, 2002.

(51) Int. Cl. H04M 11/04; H04Q 9/00; G08C 19/22

(52) U.S. Cl. 340/310.01; 340/310.02; 340/870.07

(57) ABSTRACT

A power line communication system in which communication signals, e.g. high bitrate modulated radio frequency carriers, and electrical appliance control signals, which have a low bitrate, also modulate radio frequency carriers at frequencies of the same order as the frequencies of the high bitrate modulated carriers are applied to the power line which energizes the appliances. Transceivers are coupled to the power line, to communications devices and to appliance control devices for receiving the carriers and supplying demodulated signals to the respective devices and for supplying carriers to the power line modulated by signals received from the respective devices.

### RELATED APPLICATION

The benefit of priority of provisional application No. 60/345,824, filed on Jan. 8, 2002 in the names of the inventors named herein, is claimed.

### FIELD OF THE INVENTION

The invention relates to communication systems using radio frequency carriers and, particularly, to communication systems in which electrical power lines, i.e. electrical conductors which transmit electrical energy in the low voltage range of 100-300 rms volts at frequencies from 20-100 cycles per second to energize home appliances such as lights, heating, ventilating and air conditioning equipment (HVAC), refrigerators, television sets, etc., also are at least part of the transmission medium for the information to be communicated, e.g. the digital signal output of communication apparatus, and the control signals for appliances energized by the electrical power supplied by the power line.

### BACKGROUND OF THE INVENTION

As used herein, the acronyms and abbreviations have the following meanings:

| | |
|---|---|
| ADC | Analog to Digital Converter |
| BPSK | Bipolar Phase Shift Keying |
| DAC | Digital to Analog Converter |
| DCC | DSSS Command and Control Device |
| DSSS | Direct Sequence Spread Spectrum |
| FFT | Fast Fourier Transform |
| GD | Gateway Device |
| HPLCS | Hybrid Power Line Communication System |
| HPS | Home Plug Special Interest Group System |
| HSCN | High Speed Communication Node |
| HVAC | Heating, Ventilating and Air Conditioning |
| IFFT | Inverse Fast Fourier Transform |
| ISP | Internet Service Provider |
| LSCN | Low Speed Communication Node |
| OFDM | Orthogonal Frequency Division Multiplexing |
| PC | Personal Computer |
| PLC | Power Line Communication |
| RF | Radio Frequency |
| RX | Radio Frequency Receiver |
| TX | Radio Frequency Transmitter |

Although the principles of the invention can be used in connection with other communication systems, the invention will be described in connection with the power line communication systems of the type developed by Enikia, Inc. in New Jersey and described at pages 100-107 of the publication entitled “The Essential Guide to Home Networking Technologies” published in 2001 by Prentice-Hall, Inc., Upper Saddle River, N.J., described in copending application Ser. No. 09/290,255 filed Apr. 12, 1999 and described in copending applications filed Jun. 28, 2000, Ser. Nos. 09/605,065 and 09/605,064 and entitled Method for Changing Signal Modulation Based on an Analysis of Power line Conditions and Method for Selecting and Changing Gears in Power line Networks, the disclosures of the copending applications being incorporated herein by reference.

Numerous power line communication systems are described in the patents identified in the copending U.S. application Ser. No. 09/290,255.

Further information as to the type of power line communication system which can be modified to include the invention is provided at the Home Plug Special Interest Group web site http://www.home plug.org and in the article entitled “Home Plug Standard Brings Networking to the Home” in the Communications System Design magazine for December 2000, Vol. 16, No. 12.

Other publications of interest are pages of the books entitled “Spread Spectrum System with Commercial Applications” by R. C. Dixon (John Wiley & Sons, 3^{rd} Ed., 1994), “OFDM for Wireless Multimedia Communications” by R. van Nee & R. Prasad (Artech Home Publishers, 2000), “Spread Spectrum (SS) Introduction”; by ir J. Meel; De Nayer Instituut; Version 2, December 1999 and “On the Architecture and Performance of an FFT-Based Spread-Spectrum Downlink RAKE Receiver”; by Shin-Yuan Wang and Chia-Chi Huang; IEEE Transactions on Vehicular Technology, Vol. 50, No. 1, January 2001.

Communication systems for remotely controlling appliances (DSSS Systems), such as HVAC appliances, are known in the art. In general, the control and command signals are sent over lines at low frequency. Such signals have a low bitrate and have not been processed by conventional power line apparatus used to process high bitrate communications, such as is used in so-called Home Plug Systems (HPS).

It would be advantageous to be able to use the power lines in a home or business building for the distribution of both the high speed data communications signals and the low speed command and control communications signals.

### BRIEF SUMMARY OF THE INVENTION

In accordance with the invention, both the low bitrate command and control signals and the high bitrate communications signals are transmitted to the home or business building low voltage power lines in a like manner, e.g. by carriers in the frequency band used for the high bitrate signals modulated by the respective signals, and the carriers are processed in receivers for such modulated carriers and channeled to the respective destinations, e.g. the appliance command control device and the high bitrate communications device.

Similarly, high bitrate signals and low bitrate signals are transmitted to the low voltage power lines on modulated carriers by a transmitter associated with the receiver.

The modulated carriers can be delivered to the low voltage power lines from high voltage power lines and from the low voltage power lines to the high voltage power lines as the carriers are so delivered in the known Home Plug System (HPS). Also, as in the HPS, the data on the carriers can be delivered to the high voltage power lines from a high speed network and from the high voltage power lines to a high speed network. Such modulated carriers can also be delivered to the power lines through a gateway coupled to a cable modem or DSL line. Such network can, for example, be the Internet.

Preferably, the carrier frequencies for the command and control signals overlap the carrier frequencies used for the high bitrate communication signals and in this case, the apparatus used in the HPS is employed to prevent interference or the command and control carrier frequencies are not used for high bitrate communications. Alternatively, the carrier frequencies can be carrier frequencies outside the range of carrier frequencies used for high bitrate communications, but within the carrier frequency range which can be processed by the system.

Although other types of carrier system can be used, preferably, OFDM is used.

Although, each unit coupled to the home or business building low voltage power lines can have a single function, e.g. output only command and control signals to a command and control device, preferably, each unit can output both such signals to a command and control device and high bitrate signals to a high bitrate communications device.

### BRIEF DESCRIPTION OF THE DRAWINGS

FIG. 1 is a schematic diagram illustrating a plurality of signal processing units coupled to low voltage power lines in a home or business building;

FIG. 2 illustrates by graphs one possible allocation of carrier frequencies for a system of the invention; and

FIG. 3 is a block diagram illustrating a preferred embodiment of the invention.

### DETAILED DESCRIPTION OF PREFERRED EMBODIMENTS

Although it will be apparent to those skilled in the art that the invention can be used with other systems, the invention will be described in connection with a conventional Home Plug System and as is conventional for HPS, preferably, the modulated carriers are orthogonal frequency division multiplexed.

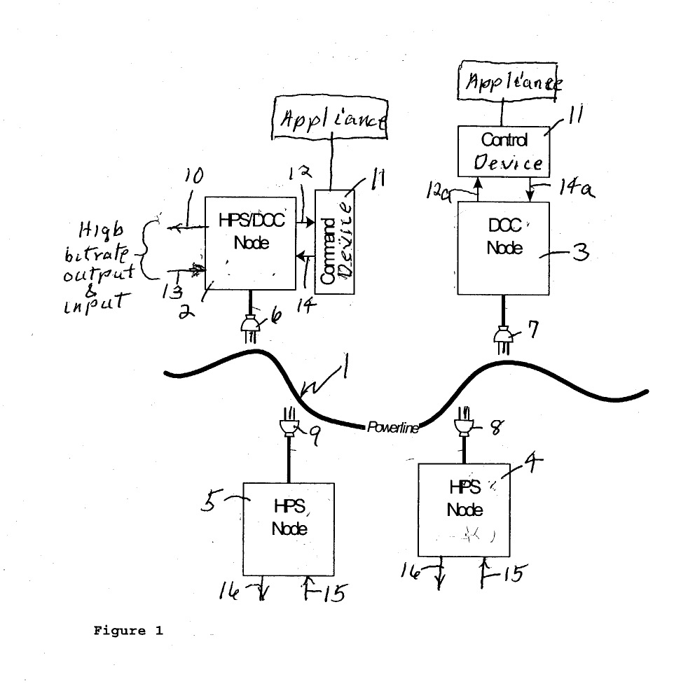

In FIG. 1, the low voltage power lines 1 in a home or business building are coupled to four different processing units, a unit 2 for processing both low bitrate command and control signal modulated carriers and high bitrate signal modulated carriers, a unit 3 for processing only command and control signal modulated carriers, a unit 4 for processing e-mail signal modulated carriers and a unit 5 for processing only high bitrate signal modulated carriers. Units 3, 4 and 5 are optional, but at least unit 2 or units 3 and 5 would be used in a home or business building to provide the desired functions.

The coupling of unit 2 to the power lines 1 is schematically indicated by the plug 6 which is receivable in an outlet receptacle (not shown) connected in a conventional manner to power lines 1 which usually have three wires. Units 3, 4 and 5 are similarly coupled to the power lines 1 by, respectively, plugs 7, 8 and 9.

Unit 2 receives and processes both high bitrate communication signals and low bitrate command and control signals from the power lines 1 and supplies the high bitrate signals to a high bitrate device, such as a personal computer or a gateway, at an output port 10. The unit 2 supplies the low bitrate command and control signals to a conventional control device 11 at an output port 12 for controlling an appliance.

Unit 2 also receives high bitrate communication signals from a high bitrate device, such as the personal computer or a gateway at an input port 13 and supplies carriers modulated with such high bitrate signals to the power lines 1. Similarly, the unit 2 receives low bitrate signals from a control device 11 at an input port 14 and supplies carriers modulated with such low bitrate signals to the power lines 1.

The unit 3 is similar to unit 2 except for the omission of the high bitrate signal processing, i.e. the unit 3 can receive a process only low bitrate command and control signals. Thus, the unit receives from, and transmits to, the power lines 1 carriers modulated with the low bitrate signals and supplies to, and receives from, the appliance control device 11 low bitrate signals by way of the output port 12a and input port 14a.

Units 4 and 5 comprise conventional HPS apparatus for receiving HPS carriers from, and supplying HPS carriers to, the power lines 1 and having input and output ports 15 and 16, respectively for coupling to high bitrate communication devices. For example, the input and output ports of the unit 4 can be coupled to e-mail apparatus and the input and output ports of the unit 5 can be coupled to a computer.

In the embodiment illustrated in FIG. 1, units 2, 4 and 5 can communicate with each other whereas unit 3 can communicate with unit 2 and not units 4 and 5. However, unit 2 can communicate commands to, and receive status information from, unit 3. For example, if the control device 11 is an HVAC appliance control device, unit 2 can control conditions such as “on”, “off”, “AC mode”, “heat mode”, “temperature”, etc. Of course, since unit 3 is coupled to the power lines 1 which can be coupled to the Internet, the appliance or appliances coupled to the control device 11 can be controlled by apparatus having Internet access.

Preferably, like HPS, communication with DCC's will use multiple, redundant DSSS channels or carrier frequencies. The center frequencies for these channels can be within the frequency band of HPS, which, at the present time, is from about 4 MHz to about 21 MHz, but can also be outside such frequency band. Any one of a number of carrier modulation techniques can be used. DSSS channels are well suited for low speed communication on the power lines because of the advantages described in the above-identified article entitled “Spread Spectrum (SS) Introduction”.

Preferably, several redundant DCC channels located at widely different frequencies will be used. Additionally and alternatively, an intelligent search algorithm, such as is used with HPS, can be used to identify the optimal channel to use. A single channel would be used at any one time to reduce implementation costs. Multiple channels need to be allocated because of a characteristic of the power line medium to attenuate signals selectively, by frequency, along the length of the network. This attenuation changes as loads are switched in and out, as well as when noise sources, which may also block specific frequency bands, are switched on and off. Multiple and/or intelligently searched DSSS signal frequencies will insure that every DCC receiver on a given power line network will, with a high probability, have a least one useable DCC channel available.

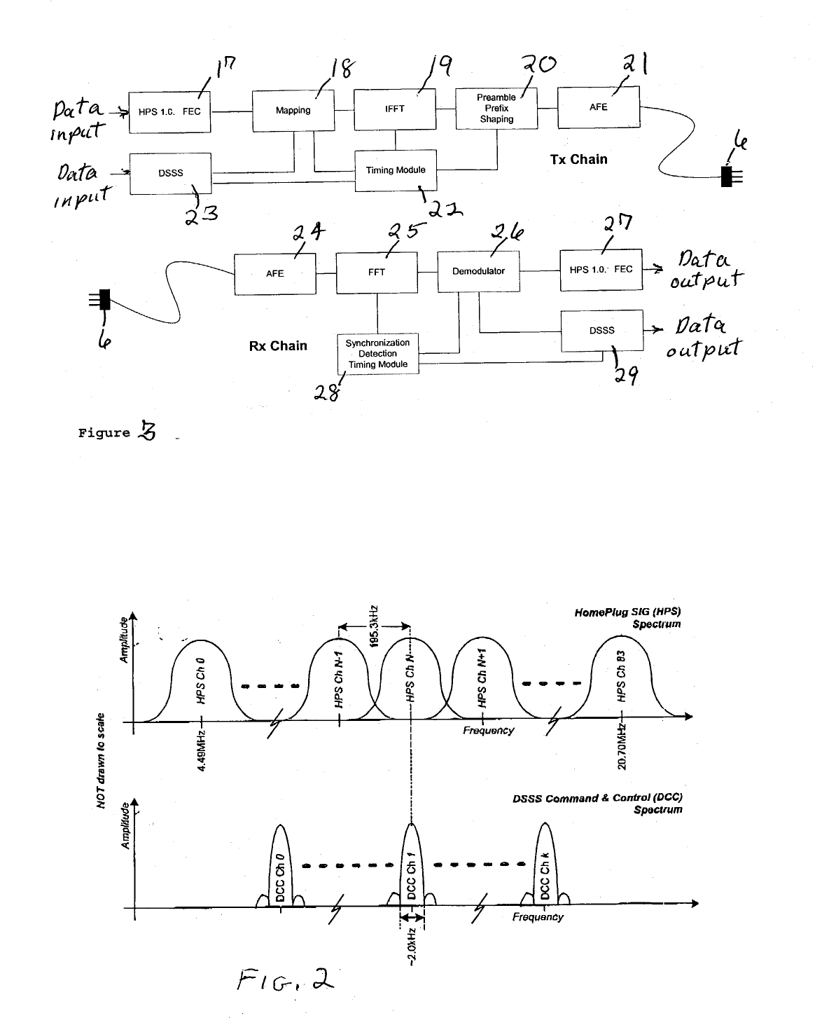

FIG. 2 has graphs illustrating allocation of carrier frequencies for the low bitrate carriers within the carrier frequency band now allocated to HPS. Not all carrier frequencies within the band are allocated to HPS as illustrated in the top graph in FIG. 2.

Low bitrate DCC communications can readily take place within an HPS channel with any of several modulation schemes. For example, a 1 kb/s DCC data rate signal modulated with BPSK has a DSSS lobe-to-lobe width of 2.0 kHz (1^{st} side lobe—13 dB (see above-identified book by R. C. Dixon). This signal will fit comfortably inside a single HPS channel.

The HPS standard requires transceivers to support an OFDM channel-masking feature. This feature allows individual channels to be selectively enabled and disabled while transmitting and ignored while receiving. This feature allows DCC transceivers to use specific HPS channels for communications. In this case, a coordination protocol must be enabled on all HPS devices on the network, which directs transceivers to mask preassigned DCC channels.

If the DCC channel frequencies are chosen outside the HPS band, no HPS coordination is needed.

A particular implementation based on the ideas and principles is described here. In this particular embodiment, OFDM based communication is designed to comply with the HomePlug Powerline Alliance Specification 1.0 (HPS). Gateway (GD) device is implemented based on the power line communication physical layer interface that is designed to comply with HPS and also contains enhancements that allow the same physical layer interface to communicate with DSSS based systems. In this embodiment, this functionality is achieved through overall system re-configurability and flexibility that is achieved through high degree of the device programmability.

The issue of the cost efficiency is solved in this system through the implementation of the GD type communication node. This approach allows for reliable communication of devices not capable of direct communication otherwise (direct communication between LSCN or low bitrate and HSCN type of nodes).

Furthermore, cost effectiveness of the GD node is achieved through the use of the same physical layer interface and medium access control engine to perform both HSCN and LSCN specific modulations and protocols.

Key HSCN/LSCN communications parameters, compatibility issues and issues related to extending HPS transceivers to DCC capability are described in the following sections.

The main challenge is in the creation of a communication path between two nodes where the first node has an HPS Compliant Tx-Rx chain and the second node has a DSSS Rx-Tx chain.

By forcing the HPS compliant Tx chain to transmit a sequence of symbols with carriers active in a fashion that mimics DSSS (symbol rate=chip rate) we can create DSSS signal that can be understood by a low bitrate DSSS Rx node. Therefore, the Rx chain of a low bitrate node implementation can be a pretty simple one. That would work well for application where an HPS node needs to communicate with simple devices such as dimmers, light switches, thermostats, etc.

The modification of an HPS transceiver which can be used for the HPS/DCC Node 11 in FIG. 1 is illustrated in FIG. 3. In FIG. 3, blocks 17, 18, 19, 20, 21 and 22 are components of the known HPS transmitter except that mapping component 18 is modified to provide two algorithms, one for HPS channel selection and one for DCC channel selection, and except that component 20 is modified to also support symbol timing adjustment to mimic a DSSS signal.

In added component 23, the data input is connected to DSSS signals. The timing module 22 will also specify the symbol timing rate based upon the number of DSSS channels used and the bitrate of each channel.

On the receiver side of the transceiver illustrated in FIG. 3, blocks 24-28 are components of the known HPS receiver except that the demodulator 26 is modified to support two decoding algorithms, one for HPS decoding and one for DSSS decoding and except that the timing module 28 is modified to detect and synchronize based on a DSSS signal.

In added component 29, the DSSS signals are converted to data output.

Although preferred embodiments of the present invention have been illustrated and described, it will be apparent to those skilled in the art that various modifications may be made without departing from the principles of the invention.

What we claim is:

1. A power line communication system in which the power lines provide low voltage power to energize appliances, the system comprising:
a source of high frequency carriers modulated by low bitrate command and control signals and a source of high frequency carriers modulated by high bitrate communication signals, the low bitrate modulated carriers and the high modulated carriers having frequencies of the same order, for providing the low bitrate modulated carriers and the high bitrate modulated carriers to the power lines;
a control device for controlling the condition of an appliance coupled to the power lines which control device is operable by the low bitrate command and control signals;
a receiver for coupling to the power line for receiving high frequency carriers modulated with the low bitrate signals; the receiver including a demodulator for demodulating the low bitrate signal modulated carriers and coupled to the control device for supplying the low bitrate signals to the control device.

2. A power line communication system as set forth in claim 1 wherein the frequencies of the low bitrate carriers overlap the frequencies of the high bitrate carriers.

3. A power line communication system as set forth in claim 1 further comprising a communications device which is operable by high bitrate communication signals and wherein the receiver also receives high bitrate modulated carriers and the demodulator also demodulates the high bitrate modulated carriers and is coupled to the communications device for supplying the high bitrate signals to the communications device.

4. A power line communication system in which the power lines provide low voltage power to energize appliances, the system comprising:
a control device for controlling the condition of an appliance coupled to the power lines which control device is operable by low bitrate command and control signals;
a communications device which is operable by high bitrate communication signals; and
a receiver for coupling to the power lines for receiving high frequency carriers modulated with the low bitrate and high bitrate signals; the receiver including a demodulator for demodulating the low bitrate and high bitrate signal modulated carriers and coupled to the communications device and the control device supplying the low bitrate signals to the control device and the high bitrate signals to the communication device.

5. A power line communication system as set forth in claim 4 further comprising:
a transmitter for coupling to the power lines for supplying high frequency carriers to the power lines;
a modulator coupled to the control device, the communications device and the transmitter for receiving low bitrate signals from the control device and high bitrate signals from the communications device and for modulating the high frequency carriers supplied to the power lines with the low bitrate signals and the high bitrate signals. communication signals; and
a receiver for coupling to the power lines for receiving high frequency carriers modulated with the low bitrate and high bitrate signals; the receiver including a demodulator for demodulating the low bitrate and high bitrate signal modulated carriers and coupled to the communications device and the control device supplying the low bitrate signals to the control device and the high bitrate signals to the communication device.

5. A power line communication system as set forth in claim 4 further comprising:
a transmitter for coupling to the power lines for supplying high frequency carriers to the power lines;
a modulator coupled to the control device, the communications device and the transmitter for receiving low bitrate signals from the control device and high bitrate signals from the communications device and for modulating the high frequency carriers supplied to the power lines with the low bitrate signals and the high bitrate signals.

6. A power line communication system as set forth in claim 1 wherein the sources of the modulated high frequency carriers is a gateway.

7. A power line communication system as set forth in claim 6 further comprising a communications device which is operable by high bitrate communication signals and wherein the receiver also receives high bitrate modulated carriers and the demodulator also demodulates the high bitrate modulated carriers and is coupled to the communications device for supplying the high bitrate signals to the communications device.

8. A power line communication system in which the power lines provide low voltage power to energize appliances, the system comprising:
a transmitter coupled to the power lines for supplying a plurality of high frequency carriers modulated by at least one of low bitrate signals and high bitrate signals to the power lines;
at least one of a control device and a communications device coupled to the transmitter for supplying low bitrate signals to the transmitter by the control device and high bitrate signals to the transmitter by the communications device;
a receiver coupled to the power lines for receiving the modulated high frequency carriers, the receiver having a demodulator for demodulating carriers received from the power lines which demodulator is coupled to at least one of the control device and the communications device for supplying low bitrate signals to the control device and high bitrate signals to the communications device.

9. A power line communication system as set forth in claim 8 wherein the transmitter is a transmitter for supplying both high frequency carriers modulated by low bitrate signals and high frequency carriers modulated by high bitrate signals, the carriers having frequencies of the same order, and the demodulator of the receiver is coupled to both the control device and to the communications device for supplying low bitrate signals to the control device and high bitrate signals to the communications device.

10. A power line communication system as set forth in claim 9 wherein the high frequency carriers have frequencies within a selected frequency band and the low bitrate modulated carriers have frequencies different from the frequencies of the high bitrate modulated carriers.

11. A power line communication system in which the power lines provide low voltage power to energize appliances and in which there are communications devices operable by and supplying high bitrate communications signals and appliance control devices operable by and supplying low bitrate control signals, the system comprising:
at least one transceiver coupled to a communications device and a control device and to the power lines for supplying to the power lines high frequency carriers modulated by the low bitrate control signals and the high bitrate communications signals and for receiving from the power lines and demodulating high frequency carriers modulated with low bitrate control signals and high bitrate communications signals and supplying low bitrate control signals to the control device and high bitrate communications signals to the communications device.

12. A power line communication system as set forth in claim 11, wherein a further transceiver is coupled to the power lines and to a source of low bitrate control signals and a source of high bitrate communications signals and wherein the further transceiver supplies the high frequency carriers modulated with the low bitrate control signals and the high frequency carriers modulated with high bitrate communications signals to the power lines and wherein the further transceiver receives high frequency carriers modulated with the low bitrate signals and the high frequency carriers modulated with the high bitrate communications signals from each source and supplies the received low bitrate control signals of the to the source of low bitrate control signals and the high bitrate communications signals of the received carriers to the source of the high bitrate communications signals.

13. A power line communication system as set forth in claim 12 wherein the frequencies of the high bitrate modulated carriers and the frequencies of the low bitrate modulated carriers are of the same order.

14. A power line communication system as set forth in claim 13 wherein the source of low bitrate control signals supplies high frequency carriers modulated in a first manner by the low bitrate control signals and the source of high bitrate communications signals supplies high frequency carriers modulated in a second, different manner by the high bitrate communications signals.
